(19) United States
(12) Patent Application Publication
(10) Pub. No.: US 2012/0233428 A1
(43) Pub. Date: Sep. 13, 2012

(54) APPARATUS AND METHOD FOR SECURING PORTABLE STORAGE DEVICES

(75) Inventors: Steven V. BACASTOW, Cumming, GA (US); Richard M. Terrell, Cumming, GA (US)

(73) Assignee: Six Circle Limited Liability Company, Wilmington, DE (US)

(21) Appl. No.: 13/427,561

(22) Filed: Mar. 22, 2012

Related U.S. Application Data
(62) Division of application No. 13/175,214, filed on Jul. 1, 2011.
Application No. 13/175,214 is a continuation of application No. 11/807,008, filed on May 26, 2007, now abandoned.
(60) Provisional application No. 60/803,600, filed on May 31, 2006.

(51) Int. Cl. G06F 12/14

(52) U.S. Cl. 711/163; 711/E12.091

(57) ABSTRACT

An apparatus and method for controlling and securing information stored on portable USB storage devices. Using the software application stored on the USB storage device in conjunction with functionality performed by a designed server, use of the storage device is limited to authorized users, PCs and locations, and other criteria while information contained within the device is protected from unauthorized access.

### RELATED APPLICATION

Provisional Patent Application 60/803,600 filed on May 31, 2006.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates to an apparatus and method for securing data and controlling the functionality of applications executing from portable USB storage devices. More specifically, the present invention relates to an apparatus and method for remotely controlling and securing portable USB storage devices containing data and information using software, configuration files and secret information carried in the portable USB storage device.

### BACKGROUND OF THE INVENTION

Today, more than ever before, it is important to protect personal and corporate information from theft or accidental disclosure. While most corporate security policies maintain stringent standards for information protection, recent Sarbanes Oxley legislation raises the bar for internal controls over corporate assets including electronic data. Portable USB storage devices often fall outside of the protection of the general data processing control environment. This invention effectively extends the general data processing control environment to fully protect information stored on portable USB storage devices such as USB flash memory, USB hard-disc and other USB storage devices.

There has been a significant increase in the use of portable USB storage devices to store, backup, and transfer information between PCs and locations. Conventional methods for storing data and information on these devices often lack proper security and a user may on occasion lose or misplace a portable USB storage device that contains sensitive or private information.

Many people, corporations and government agencies are uncomfortable with allowing employees and other authorized personnel to utilize portable USB storage devices to store or transfer data and information. For example, if a device with sensitive or private information is lost or stolen, there is no currently available method to remotely disable the portable USB storage device from further use.

Current methods also lack the ability to allow a person, corporation or government agency to control the PCs, times or locations from which portable USB storage devices may be utilized.

Current methods also lack the ability to remotely authenticate the authorized users and uses of portable USB storage devices.

Therefore, a need exists for an apparatus and method for remotely controlling and securing portable USB storage devices that addresses these shortcomings in the prior art.

### SUMMARY OF THE INVENTION

The present invention answers this need by providing an apparatus and method for remotely securing information stored on portable USB storage devices and centrally controlling the location, time, frequency and PC from which these devices may be used.

Software is either pre-loaded and configured on the USB storage device or installed and configured from the internet, intranet, CD or other means. Software is further configured to accommodate additional levels of security validation as required by the user or organization. The configuration of security levels may vary between devices and organizations and is controlled by a central rules database or rules ‘engine’ via interne or intranet connection.

In an embodiment of the present invention, the portable USB storage device is configured to require the software installed on the portable USB storage device to authenticate itself with a designated file server. This authentication may take the form of user-id and password that are secretly stored on the portable USB storage device and additional secret information to uniquely identify the USB storage device—as appropriate. If the portable USB storage device is not authorized by the server (for example—because it has been reported as lost or stolen), the software will immediately terminate and data stored on the portable USB storage device will not be accessible.

In other embodiments of the invention additional levels of security are provided via internet or intranet connection in order to remotely authenticate a portable USB storage device. These additional levels of security would specify that additional secret information be transmitted from the portable USB storage device to a designated server via the internet or intranet. This secret information may be in the form of a digital certificate, token, or other secret information stored on (or created from) the portable USB storage device that uniquely identifies the portable USB storage device from any other otherwise similar or identical device. If the additional secret information is not correctly transmitted and accepted by the designated server, the software will not fully function and data stored on the portable USB storage device will not be accessible.

In still other embodiments of the invention additional levels of security are provided in order to remotely control the location or locations from which the portable USB storage device may be used. This additional level of security would only allow the software to function if the portable USB storage device is operated within a pre-defined physical (or logical) location or acceptable ranges of locations. Logical location is determined by IP address or range of IP addresses from which the host computer is operating. Physical location is determined by several available methods including but not limited to: Cellular Data Transmission information (CDT), Radio Frequency Identification (RFID) information, and Global Positioning System (GPS) information. Irrespective of the method, if the logical or physical location from which the portable USB storage device is being used is not within the pre-defined approved area or areas, the software will not fully function and data stored on the portable USB storage device will not be accessible.

In still other embodiments of the invention additional levels of security are provided in order to control the PC (or PCs) that may be used to operate the portable USB storage device. Information that uniquely identifies each authorized PC (such as but not limited to MAC address or other embedded information such as an RFID tag) is configured into the portable USB storage device during initialization via internet or intranet connection. If the portable USB storage device is inserted into another PC which has not been pre-defined as a valid host (via MAC address, RFID, or other suitable means), the software will not function and data stored on the portable USB storage device will not be accessible.

In still other embodiments of the invention additional levels of security are provided in order to remotely control the frequency in which information may be stored or accessed on the portable USB storage device. The portable USB storage device is configured via Internet or intranet connection to allow a finite number of uses within a specified time frame or time interval. If the frequency of use exceeds the configured limits, the software will not fully function and data stored on the portable USB storage device will not be accessible.

In still other embodiments of the invention additional levels of security are provided in order to remotely control the time of day that the portable USB storage device may be utilized. The portable USB storage device is configured via internet or intranet connection to allow the software to function within a specified combination of valid: time of day, day of the week, month, year or any specific date or dates. If the time of requested use falls outside of the configured timeframes, the software will not fully function and data stored on the portable USB storage device will not be accessible.

In still other embodiments of the invention additional levels of security are provided in order to control the user of (or uses of) the portable USB storage device. At specific times or based on specific events, the user will be prompted to supply additional secret information or biometric data as a prerequisite to continued authorized use of the invention. This information or biometric data would only be known or possessed by the authorized user. If the additional information or biometric data is not provided when prompted, the software will not fully function and data stored on the portable USB storage device will not be accessible.

It is thus an advantage of the present invention to provide an apparatus and method for controlling and securing information stored on portable USB storage devices To this end, the present invention is new and unique in both its conception and implementation.

Embodiments of the present invention are described below by way of illustration. Other approaches to implementing the present invention and variations of the described embodiments may be constructed by a skilled practitioner and are considered within the scope of the present invention.

### BRIEF DESCRIPTION OF THE DRAWINGS

FIG. 1 is a general overview of the process whereby the USB storage device authenticates with the remote server via internet or intranet connection which is an embodiment of the present invention.

FIG. 2 is a general overview of the process whereby the USB storage device authenticates with the remote server via internet or intranet connection and an optional second token validation server which is an embodiment of the present invention.

FIG. 3 is description of the process whereby the MAC address of the host PC is validated which is an embodiment of the present invention.

FIG. 4 is a general overview of the process whereby the USB storage device authenticates with the remote server via internet or intranet connection to validate the location of the host PC using cellular transmission information which is an embodiment of the present invention.

FIG. 5 is a general overview of the process whereby the USB storage device (using required biometric input) authenticates with the remote server via internet or intranet connection and an optional second token validation server which is an embodiment of the present invention.

FIG. 6 is a general overview of the process whereby the USB storage device authenticates with the remote server via Internet or intranet connection to validate the logical address of the host PC using IP address which is an embodiment of the present invention.

FIG. 7 is a general overview of the process whereby the USB storage device contains an RFID tag that serves to control where the device can function, which is an embodiment of the present invention.

FIG. 8 is a general overview of the process whereby the USB storage device authenticates with the remote server via Internet or intranet connection to validate the GPS location associated with the RFID tag of the host PC which is an embodiment of the present invention.

FIG. 9 is a general overview of the process whereby the USB storage device authenticates with the remote server via Internet or intranet connection to validate the GPS location associated with the unique secret identification number of the USB storage device which is an embodiment of the present invention.

FIG. 10 is a general overview of the process whereby the USB storage device authenticates with the locally attached PC or remote server via Internet or intranet connection to validate the date and time that the device is being used which is an embodiment of the present invention.

FIG. 11 is a general overview of the process whereby the USB storage device authenticates with the locally attached PC or remote server via Internet or intranet connection to validate the frequency (or velocity) with which the device is being used which is an embodiment of the present invention.

FIG. 12 is a general overview of the process whereby the central configuration database or ‘rules engine’ is updated and information is subsequently forwarded via internet or intranet connection to the portable USB storage device for its ongoing configuration which is an embodiment of the present invention.

### DETAILED DESCRIPTION OF THE INVENTION

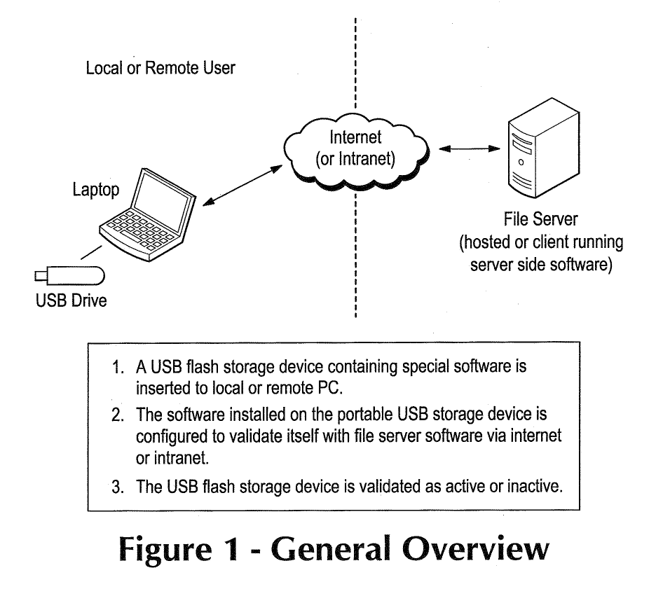

With reference to FIG. 1, A USB storage device containing software is inserted to local or remote PC. The software installed on the portable USB storage device is configured to validate itself with file server software via internet or intranet connection. The USB flash storage device is validated as active or inactive. If active, the software on the portable USB storage device functions normally. If inactive or no connection via internet or intranet connection the software will not fully function and the information stored on the portable USB storage device cannot be accessed.

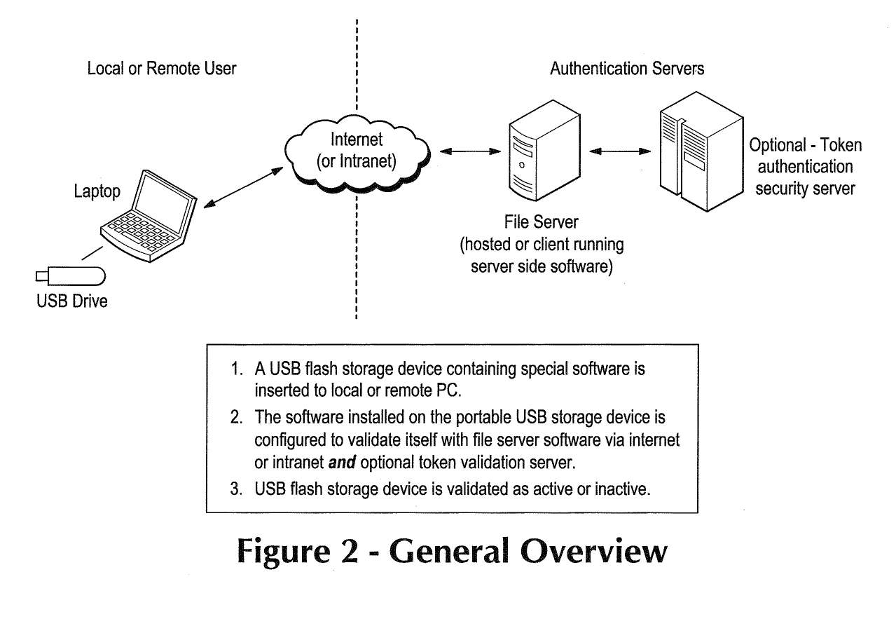

With reference to FIG. 2, a USB flash storage device containing software is inserted to local or remote PC. The software installed on the portable USB storage device is configured to validate itself with QuickVault server software and optional token validation server via internet or intranet connection. USB flash storage device is validated as active or inactive. If active, the token is validated by the token authentication server. If the token is validated, the software on the portable USB storage device functions normally. If the token is not validated, the software on the portable USB storage device will not fully function. If inactive or no connection via internet or intranet connection the software will not fully function and the information stored on the portable USB storage device cannot be accessed.

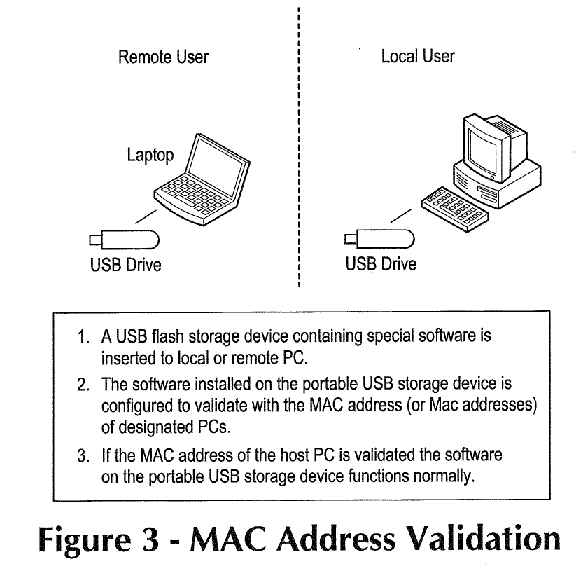

With reference to FIG. 3, a USB flash storage device containing software is inserted to a local or remote PC. The software installed on the portable USB storage device is configured to validate with the MAC address or MAC addresses of designated PCs. If the MAC address of the host PC is validated the software on the portable USB storage device functions normally. If the MAC address is not validated, the software on the portable USB storage device will not fully function and the information stored on the portable USB storage device cannot be accessed.

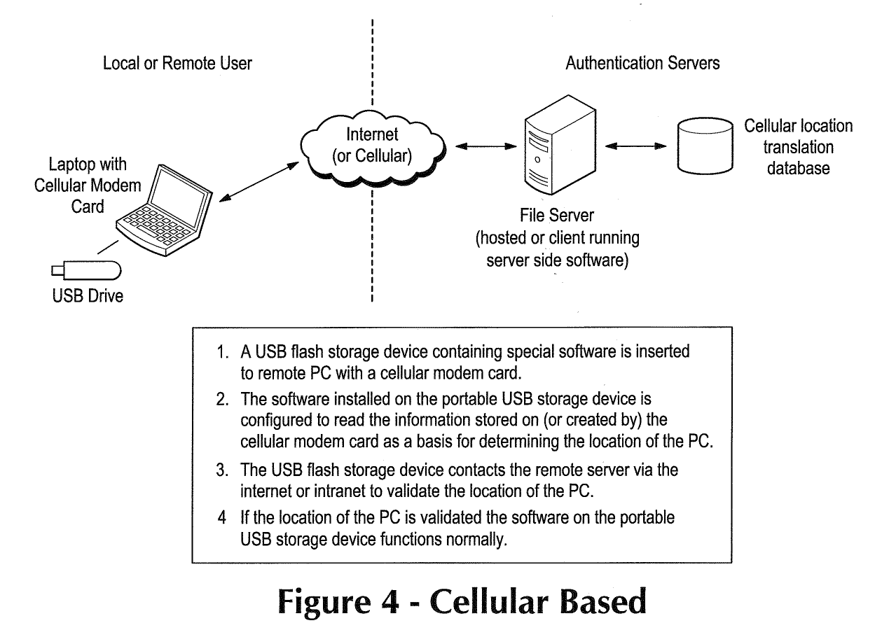

With reference to FIG. 4, a USB flash storage device containing software is inserted to remote PC with a cellular modem card. The software installed on the portable USB storage device is configured to read the information stored on (or created by) the cellular modem card as a basis for determining the current approximate physical location of the host PC. The USB flash storage device contacts the file server via internet or intranet connection to validate the location of the PC. If the location of the PC is validated the software on the portable USB storage device functions normally. If the location of the PC is not validated, the software on the portable USB storage device will not fully function and the information stored on the portable USB storage device cannot be accessed. If no connection to the server via internet or intranet connection the software will not fully function.

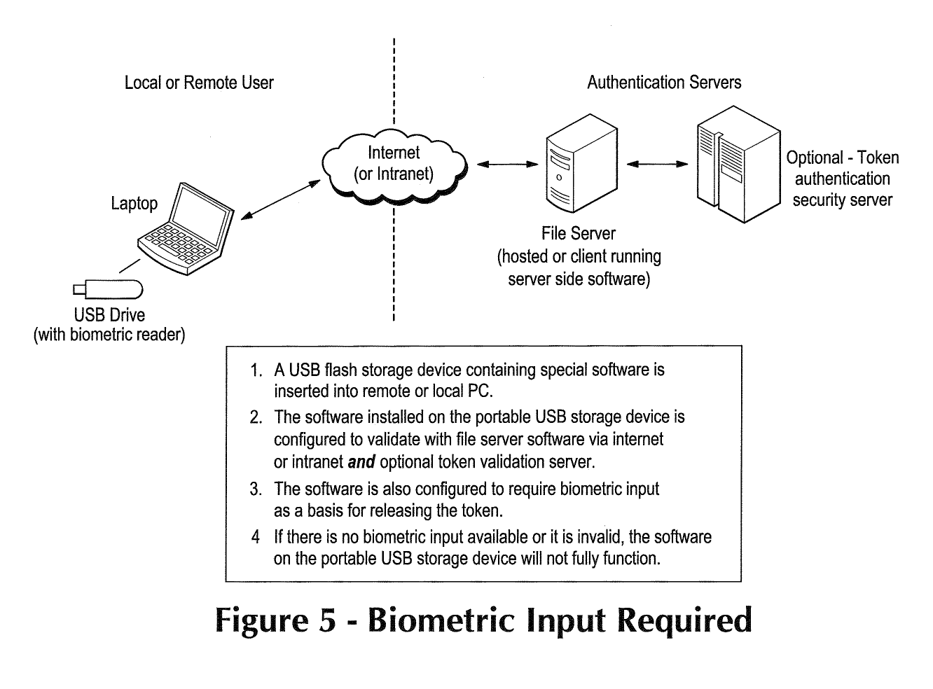

With reference to FIG. 5, a USB flash storage device containing software is inserted into a remote or local PC. The software installed on the portable USB storage device is configured to validate with the file server software and optional token validation server via internet or intranet connection. The software is also configured to require biometric input as a basis for releasing the token. If there is no biometric input available or it is invalid, the software on the portable USB storage device will not fully function. If valid biometric input is provided, the token is released. The USB flash storage device is first validated as active or inactive by the file server via internet or intranet connection. If active, the released token is validated by the token authentication server. If the token is validated, the software on the portable USB storage device functions normally. If the token is not validated, the software on the portable USB storage device will not fully function and the information stored on the portable USB storage device cannot be accessed. If inactive or no connection via Internet or intranet connection the software will not fully function.

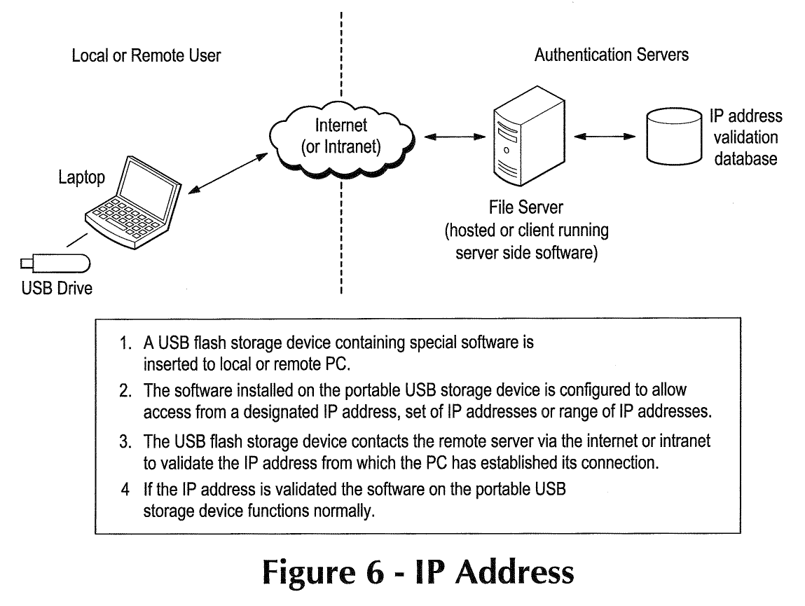

With reference to FIG. 6, a USB flash storage device containing software is inserted to local or remote PC with a NIC card. The software installed on the portable USB storage device is configured to allow access from a designated IP address, set of IP addresses or range of IP addresses. The USB flash storage device contacts the file server via internet or intranet connection to validate the IP address from which the PC has established its connection. If the IP address is validated the software on the portable USB storage device functions normally. If the IP address is not validated, the software on the portable USB storage device will not fully function and the information stored on the portable USB storage device cannot be accessed. If no connection via internet or intranet connection to the server the software will not fully function.

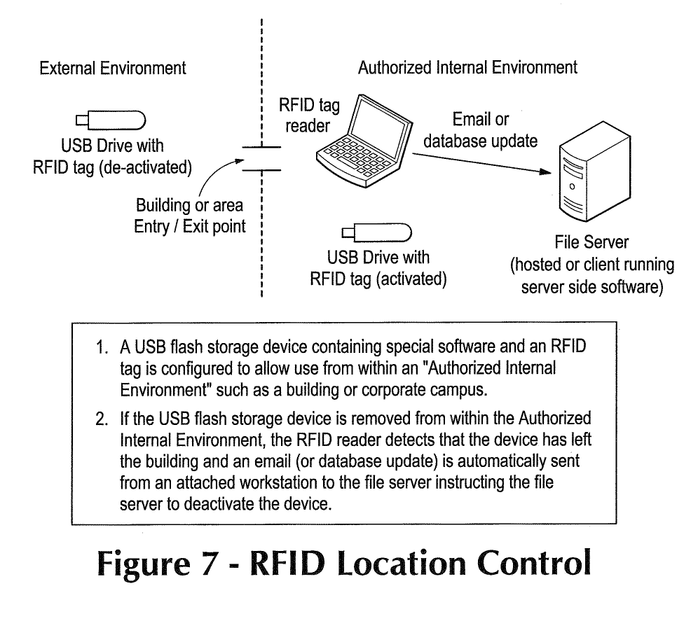

With reference to FIG. 7, a USB flash storage device containing software and an RFID tag is configured to allow use from within an “Authorized Internal Environment” such as a building or corporate campus. RFID tag readers are installed at designated building entry and exit points. If the USB flash storage device is removed from within the Authorized Internal Environment from a designated entry or exit point, the RFID reader detects that the device has left the building and an email (or database update) is automatically sent from an attached workstation to the file server via Internet or intranet connection instructing the file server to deactivate the device. If the USB flash storage device is returned to the Authorized Internal Environment from a designated entry or exit point, the RFID reader detects that the device has returned to the building and an email (or database update) is automatically sent from an attached workstation to the file server via internet or intranet connection instructing the file server to reactivate the device. While the device is in a deactivated state, the software on the portable USB storage device will not fully function and the information stored on the portable USB storage device cannot be accessed.

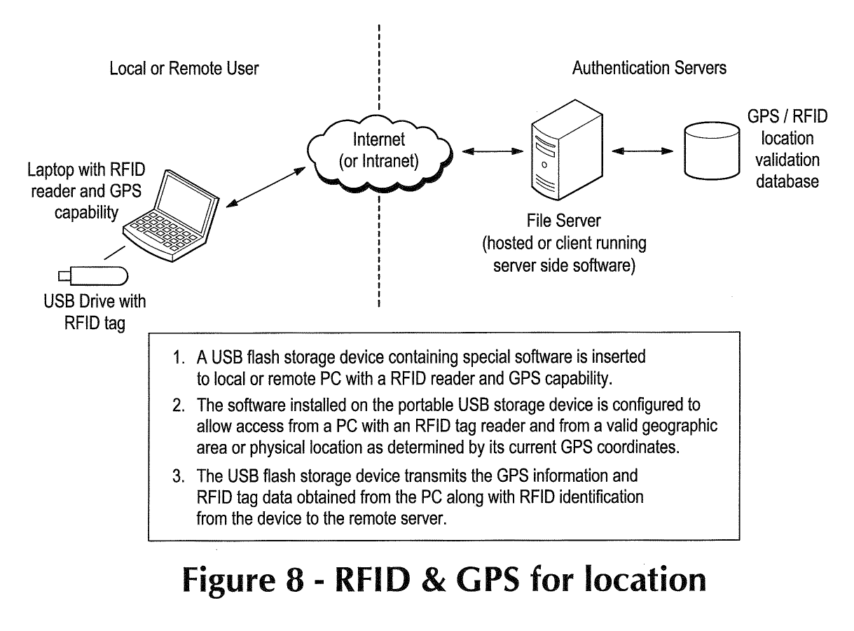

With reference to FIG. 8, a USB flash storage device containing software is inserted to local or remote PC with a RFID reader and GPS capability. The software installed on the portable USB storage device is configured to allow access from a PC from a valid geographic area or physical location as determined by its current GPS coordinates. The RFID tag data that is read from the portable USB storage device is first compared to the RFID information stored in the device database. If the RFID tag data matches the data stored in the database the software on the portable USB storage device functions normally. If there is no match or if there is no RFID tag on the device, the software on the portable USB storage device will not fully function and the information stored on the portable USB storage device cannot be accessed. Next, the USB flash storage device transmits the GPS information obtained from the PC along with the RFID identification from the device to the remote server via internet or intranet connection. If the RFID tag is validated for the GPS location, the software on the portable USB storage device functions normally. If the RFID tag is not validated for the GPS location, the software on the portable USB storage device will not fully function and the information stored on the portable USB storage device cannot be accessed. If no connection to the server via internet or intranet connection the software on the device will locally validate the GPS location. If the RFID tag is validated for the GPS location, the software on the portable USB storage device functions normally. If the RFID tag is not validated for the GPS location, the software on the portable USB storage device will not fully function and the information stored on the portable USB storage device cannot be accessed.

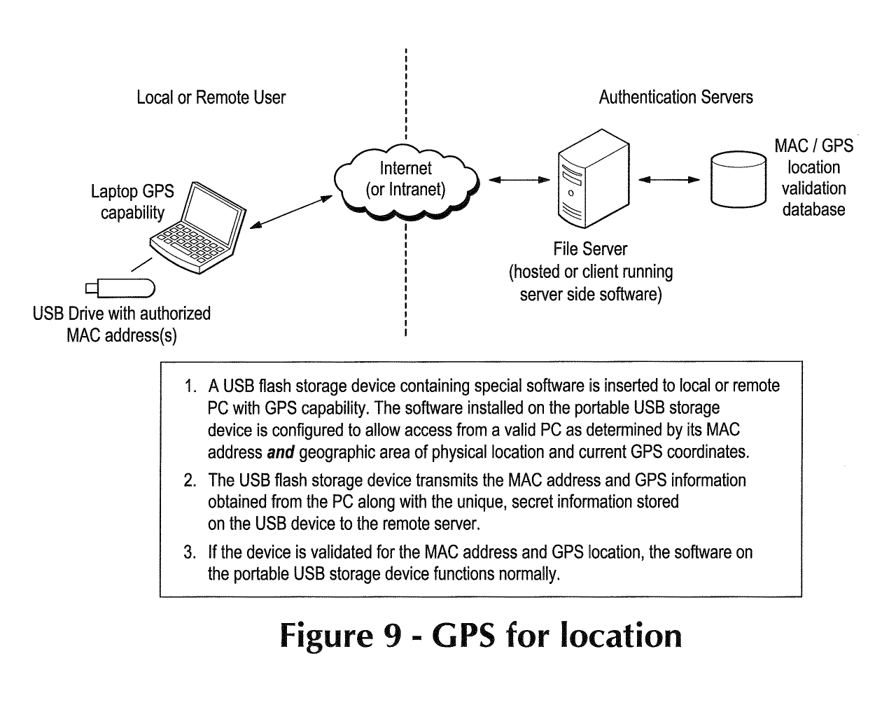

With reference to FIG. 9, a USB flash storage device containing software is inserted to a local or remote PC with GPS capability. The software installed on the portable USB storage device is configured to allow access from a valid PC as determined by its MAC and from a valid geographic area or physical location as determined by its current GPS coordinates. The USB flash storage device transmits the MAC address and GPS information obtained from the PC along with the unique, secret identification of the USB device to the remote server via interne or intranet connection. If the device is validated for the GPS location, the software on the portable USB storage device functions normally. If the device is not validated for the MAC address and GPS location, the software on the portable USB storage device will not fully function and the information stored on the portable USB storage device cannot be accessed. If no connection to the server via interne or intranet connection the software on the device will locally validate the MAC address and GPS location. If the device is validated for the MAC address and GPS location, the software on the portable USB storage device functions normally. If the device is not validated for the MAC address and GPS location, the software on the portable USB storage device will not fully function and the information stored on the portable USB storage device cannot be accessed.

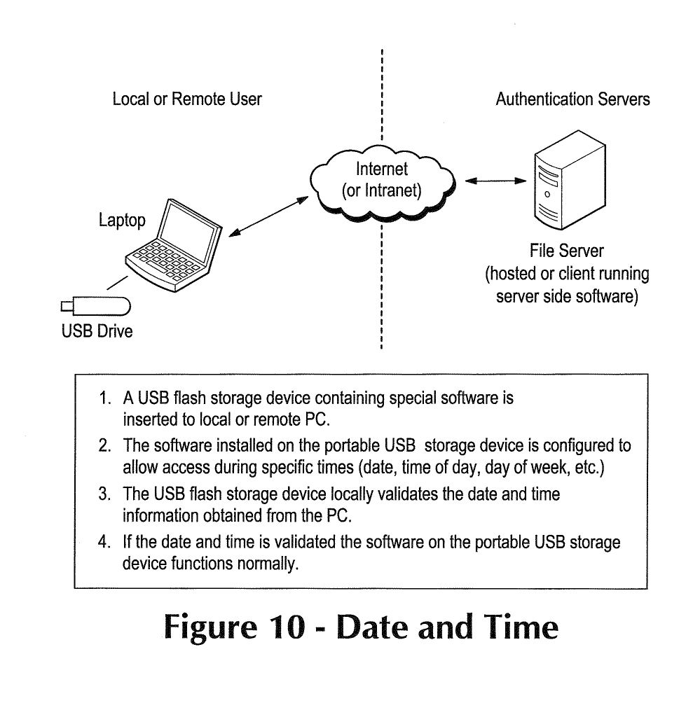

With reference to FIG. 10, a USB flash storage device containing software is inserted to a local or remote PC. The software installed on the portable USB storage device is configured to allow access during specific times (date, time of day, day of the week, etc.) The USB flash storage device locally validates the date and time information obtained from the PC. If the date and time is validated the software on the portable USB storage device functions normally. If the date and time is not validated, the software on the portable USB storage device will not fully function and the information stored on the portable USB storage device cannot be accessed. The software on installed on the portable USB storage device may optionally be configured to contact the server via Internet or intranet connection to obtain current date and time information. If the date and time is validated the software on the portable USB storage device functions normally. If the date and time is not validated, the software on the portable USB storage device will not fully function and the information stored on the portable USB storage device cannot be accessed.

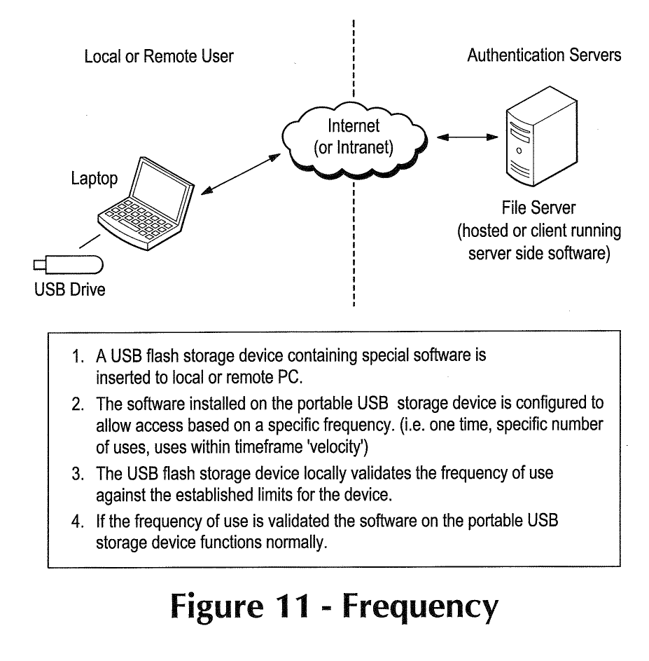

With reference to FIG. 11, a USB flash storage device containing software is inserted to local or remote PC. The software installed on the portable USB storage device is configured to allow access based on a specific frequency. (one time, specific number of uses, uses within timeframe ‘velocity’) The USB flash storage device locally validates the frequency of use against the established limits for the device. If the frequency of use is validated the software on the portable USB storage device functions normally. If the frequency of use is not validated, the software on the portable USB storage device will not fully function and the information stored on the portable USB storage device cannot be accessed. The software on installed on the portable USB storage device may optionally be configured to contact the server to obtain use frequency validation information. If the frequency of use is validated the software on the portable USB storage device functions normally. If the frequency of use is not validated, the software on the portable USB storage device will not fully function and the information stored on the portable USB storage device cannot be accessed.

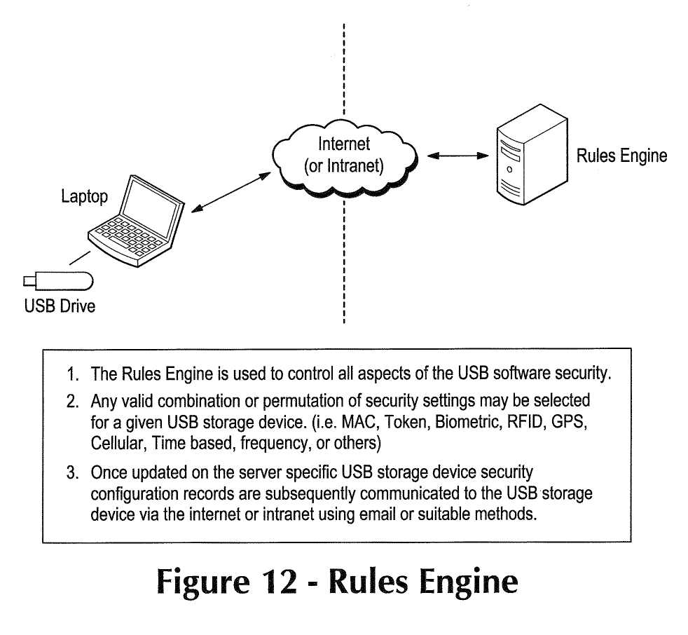

With reference to FIG. 12, The File Server is used to control all aspects of the USB software security and functionality using a central security rules engine and database. Authorized system administrators working from authorized workstations via internet or intranet connection define the specific combinations of required USE device security. Any valid combination or permutation of security settings may be selected for a given USB storage device. (MAC, Token, Biometric, RFID, GPS, Cellular, Time based, frequency, or others) Once updated on the server specific USB storage device security configuration records are subsequently communicated to the USE storage device via Internet or intranet connection using email or suitable methods. The USE device reads the new configuration file and updates its internal database to coincide with new server settings.

Having thus described the invention in detail, it should be apparent that various modifications and changes may be made without departing from the spirit and scope of the present invention. Consequently, these and other modifications are contemplated to be within the spirit and scope of the following claims.

1-13. (canceled)

14. A peripheral, comprising:
an input/output interface; and
a non-volatile memory coupled to the input/output interface, the non-volatile memory including a first portion configured to store user data received over the input/output interface and a second portion having instructions stored thereon that, in response to execution by a processing device, cause the processing device to perform operations comprising:
detecting a coupling of the input/output interface to a host;
in response to detecting the coupling, determining whether a predetermined remote network device is accessible via a network interface of the host; and
preventing the host from accessing the first portion of the non-volatile memory of the peripheral in response to determining that the predetermined remote network device is not accessible via the network interface of the host.

15. The peripheral of claim 14, wherein the operations further comprise:
in response to determining that the predetermined remote network device is accessible via the network interface of the host, determining whether to permit the host to access the first portion of the non-volatile memory based on a signal received from the predetermined remote network device via the network interface of the host; and
preventing the host from accessing the first portion of the non-volatile memory in response to determining that the signal does not permit the host to access the first portion of the non-volatile memory.

16. The peripheral of claim 15, wherein the operations further comprise allowing the host to access the first portion of the non-volatile memory in response to determining that the signal does permit the host to access the first portion of the non-volatile memory.

17. The peripheral of claim 16, wherein allowing the host to access the first portion of the non-volatile memory comprises permitting the host to operate the non-volatile memory as a mass storage device of the host.

18. The peripheral of claim 14, wherein the input/output interface comprises a Universal Serial Bus (USB) interface.

19. The peripheral of claim 14, wherein the input/output interface is configured to supply power to the non-volatile memory.

20. The peripheral of claim 14, wherein detecting the coupling of the input/output interface to the host further comprises detecting the coupling of the input/output interface to a peripheral device port of the host.

21. An apparatus, comprising:
a memory device having instructions stored thereon that, in response to execution by a processing device, cause the processing device to perform operations comprising:
receiving a validation request originating from a peripheral device coupled to a host;
determining whether to prevent the host from transferring user data to or from the peripheral in response to receiving the validation request; and
transmitting a signal addressed to a network interface of the host based on a result of the determination.

22. The apparatus of claim 21, wherein the operations further comprise:
validating a token with a remote server in response to receiving the validation request; and
determining whether to prevent the host from transferring the user data to or from the peripheral based on a result of the token validation.

23. The apparatus of claim 21, wherein the operations further comprise:
determining a Media Access Control (MAC) address of the host; and
determining whether to prevent the host from transferring the user data to or from the peripheral based on the determined MAC address of the host.

24. The apparatus of claim 21, wherein the operations further comprise:
reading information stored on or created by a cellular modem card of the host; and
determining whether to prevent the host from transferring the user data to or from the peripheral based on the read information.

25. The apparatus of claim 21, wherein the operations further comprise:
comparing an Internet Protocol (IP) address of the host to a particular IP address range; and
determining whether to prevent the host from transferring the user data to or from the peripheral based on a result of the comparison.

26. The apparatus of claim 21, wherein the operations further comprise:
tracking a position of the peripheral relative to a structure by communicating with RFID reader equipment located at an entry or exit of the structure; and
determining whether to prevent the host from transferring the user data to or from the peripheral based on the current position of the peripheral relative to the structure.

27. The apparatus of claim 21, wherein the operations further comprise:
determining a current physical location of the host based on triangulation; and
determining whether to prevent the host from transferring the user data to or from the peripheral based on the current physical location of the host as indicated by the triangulation.

28. The apparatus of claim 21, wherein the operations further comprise:
receiving date and time information originating from the host; and
determining whether to prevent the host from transferring the user data to or from the peripheral based on the received date and time information.

29. A method, comprising:
detecting a coupling of an input/output interface of a peripheral to a host;
in response to detecting the coupling, determining whether a predetermined remote network device is accessible via a network interface of the host; and
preventing the host from accessing over the input/output interface a portion of a non-volatile memory that corresponds to user data in response to determining that the predetermined remote network device is not accessible via the network interface of the host.

30. The method of claim 29, further comprising:
in response to determining that the predetermined remote network device is accessible via the network interface of the host, determining whether to permit the host to access the portion of the non-volatile memory based on a signal received from the predetermined remote network device via the network interface of the host; and
preventing the host from accessing the portion of the non-volatile memory in response to determining that the signal does not permit the host to access the portion of the non-volatile memory.

31. The method of claim 30, wherein the operations further comprise allowing the host to access the portion of the non-volatile memory in response to determining that the signal does permit the host to access the portion of the non-volatile memory.

32. A method, comprising:
receiving over a network a validation request originating from a peripheral device coupled to a host using an input/output interface of the peripheral device;
determining whether to prevent the host from transferring user data to or from the peripheral device over the input/output interface in response to receiving the validation request; and
transmitting over the network a signal addressed to a network interface of the host based on a result of the determination.

33. The method of claim 30, further comprising:
checking a biometric input;
releasing a token based on a result of the checking; and
determining whether to prevent the host from transferring user data to or from the peripheral device over the input/output interface using the token.

34. The method of claim 32, further comprising determining whether to prevent the host from transferring user data to or from the peripheral device over the input/output interface using an established limit associated with frequency of use.

35. An apparatus, comprising:
means for receiving over a network a validation request originating from a peripheral device coupled to a host using an input/output interface of the peripheral device;
means for determining whether to prevent the host from transferring user data to or from the peripheral device over the input/output interface in response to receiving the validation request; and
means for transmitting over the network a signal addressed to a network interface of the host based on a result of the determination.

36. An apparatus, comprising:
means for receiving data from a host;
means for storing the data received over the receiving means;
means for determining whether a predetermined remote network device is accessible via a network interface of the host in response to the receiving means coupling to the host; and
means for preventing the host from accessing the storing means in response to determining that the predetermined remote network device is not accessible via the network interface of the host.

37. The apparatus of claim 36, further comprising:
means for determining whether to permit the host to access the storing means based on a signal received from the predetermined remote network device via the network interface of the host; and
means for preventing the host from accessing the storing means in response to determining that the signal does not permit the host to access the storing means.

38. The apparatus of claim 37, further comprising means for permitting the host to access the storing means in response to determining that the signal does permit the host to access the storing means.
